(19) United States
(12) Patent Application Publication
(10) Pub. No.: US 2022/0276367 A1
(43) Pub. Date: Sep. 1, 2022

(54) VEHICLE RADAR SYSTEM

(71) Applicant: DENSO CORPORATION, Kariya-city (JP)

(72) Inventor: Yutaka HASEGAWA, Kariya-city (JP)

(21) Appl. No.: 17/662,122

(22) Filed: May 5, 2022

Related U.S. Application Data
(63) Continuation of application No. PCT/JP2020/041357, filed on Nov. 5, 2020.

(30) Foreign Application Priority Data
Nov. 7, 2019 (JP) 2019-202344

(51) Int. Cl. G01S 13/34; G01S 13/87; G01S 13/931

(52) U.S. Cl. CPC G01S 13/341; G01S 13/87; G01S 13/931; G01S 2013/0236

(57) ABSTRACT

A vehicle radar system according to one aspect of the present disclosure includes a first radar device, a second radar device, and a third radar device. The first radar device transmits a first radar wave for which a transmission period or a transmission frequency is different from transmission periods or transmission frequencies of a second radar wave to be transmitted from the second radar device and a third radar wave to be transmitted from the third radar device. The second radar device transmits the second radar wave for which transmission polarization or a transmission beam direction is different from transmission polarization or a transmission beam direction of the third radar wave to be transmitted from the third radar device.

### CROSS-REFERENCE TO RELATED APPLICATION

This application is the U.S. bypass application of International Application No. PCT/JP2020/041357 filed on Nov. 5, 2020 which designated the U.S. and claims priority to Japanese Patent Application No. 2019-202344 filed on Nov. 7, 2019, the contents of both of which are incorporated herein by reference.

### TECHNICAL FIELD

The present disclosure relates to a vehicle radar system including three or more radar devices.

### BACKGROUND

A sensor system described in JP 2017-203735 A includes a plurality of radio wave sensors provided at an intersection. The plurality of radio wave sensors perform time division transmission or frequency division transmission to prevent occurrence of radio wave interference between the radio wave sensors. In time division transmission, the plurality of radio wave sensors transmit radio waves in periods different from each other. In contrast, in frequency division transmission, the plurality of radio wave sensors transmit radio waves at frequencies different from each other.

### SUMMARY

A vehicle radar system according to one aspect of the present disclosure includes a first radar device, a second radar device, and a third radar device. The first radar device is mountable to a vehicle. The second radar device is mountable to the vehicle. The third radar device is mountable to the vehicle. The first radar device is configured to transmit a first radar wave for which a transmission period or a transmission frequency is different from transmission periods or transmission frequencies of a second radar wave to be transmitted from the second radar device and a third radar wave to be transmitted from the third radar device. The second radar device is configured to transmit the second radar wave for which transmission polarization or a transmission beam direction is different from transmission polarization or a transmission beam direction of the third radar wave to be transmitted from the third radar device.

### BRIEF DESCRIPTION OF THE DRAWINGS

The above features of the present disclosure will be made clearer by the following detailed description, given referring to the appended drawings. In the accompanying drawings:

FIG. 1 is a view illustrating positions where radar devices included in a vehicle radar system are mounted;

FIG. 2 is a block diagram illustrating a configuration of each radar device;

FIG. 3 is a view illustrating transmission periods and transmission polarization of a front radar and peripheral radars according to a first embodiment;

FIG. 4 is a view illustrating transmission frequencies and transmission polarization of a front radar and peripheral radars according to a second embodiment; and

FIG. 5 is a view illustrating transmission periods and transmission frequencies of a front radar and peripheral radars according to a third embodiment.

### DETAILED DESCRIPTION OF THE PREFERRED EMBODIMENTS

Occurrence of radio wave interference between a plurality of sensors becomes a problem in a case where a plurality of radar devices are mounted on a vehicle. However, as a result of detailed examination, the inventor has found a problem that in a case where time division transmission is performed in a state where three or more radar devices are mounted on a vehicle, an observation period allocated to each radar device becomes short, which makes an observation distance range narrow. Further, as a result of detailed examination, the inventor has found a problem that in a case where frequency division transmission is performed in a state where three or more radar devices are mounted on a vehicle, a frequency band allocated to each radar device becomes narrow, which degrades distance resolution.

It is desirable that one aspect of the present disclosure is to obtain an appropriate detection result while preventing occurrence of radio wave interference between three or more radar devices mounted on a vehicle.

A vehicle radar system according to one aspect of the present disclosure includes a first radar device, a second radar device, and a third radar device. The first radar device is mountable to a vehicle. The second radar device is mountable to the vehicle. The third radar device is mountable to the vehicle. The first radar device is configured to transmit a first radar wave for which a transmission period or a transmission frequency is different from transmission periods or transmission frequencies of a second radar wave to be transmitted from the second radar device and a third radar wave to be transmitted from the third radar device. The second radar device is configured to transmit the second radar wave for which transmission polarization or a transmission beam direction is different from transmission polarization or a transmission beam direction of the third radar wave to be transmitted from the third radar device.

According to the vehicle radar system of the present disclosure, the transmission period or the transmission frequency of the first radar wave to be transmitted from the first radar device is different from the transmission periods or the transmission frequencies of the second radar wave to be transmitted from the second radar device and the third radar wave to be transmitted from the third radar device. Further, the transmission polarization or the transmission beam direction of the second radar wave is different from the transmission polarization or the transmission beam direction of the third radar wave. It is therefore possible to allocate an appropriate observation period and a frequency band to each radar device while preventing occurrence of radio wave interference between the first radar device, the second radar device, and the third radar device. It is therefore possible to obtain an appropriate detection result while preventing occurrence of radio wave interference between three or more radar devices.

Embodiments for implementing the present disclosure will be described below with reference to the drawings.

### First Embodiment

### <1. Configuration>

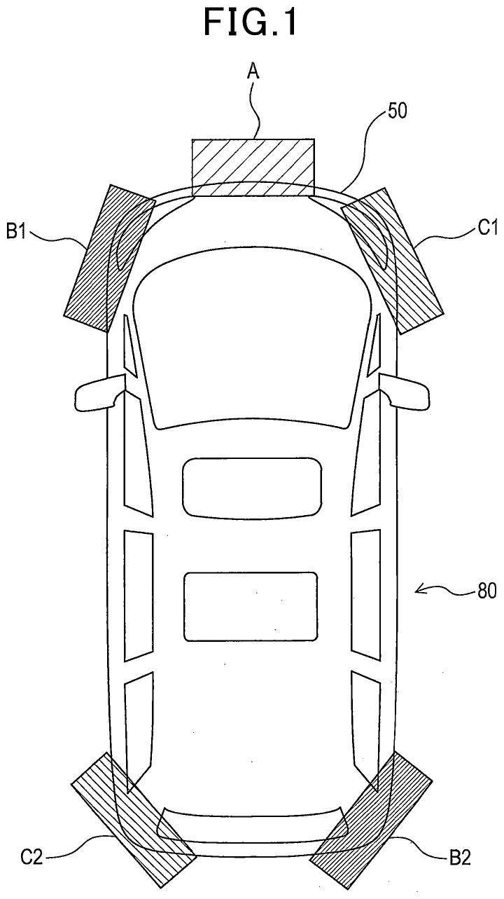

First, a configuration of a vehicle radar system 80 according to the present embodiment will be described with reference to FIG. 1. The vehicle radar system 80 includes a first radar device A, a second radar device B1, a third radar device C1, a fourth radar device B2, and a fifth radar device C2.

The first radar device A is a front radar, and the second radar device B1, the third radar device C1, the fourth radar device B2, and the fifth radar device C2 are peripheral radars.

The first radar device A is mounted at a front center (for example, at the center of a front bumper) of a vehicle 50. A detection area of the first radar device A is a region in the center of the front of the vehicle 50.

The second radar device B1 is mounted on a left front side (for example, a left end of the front bumper) of the vehicle 50. A detection area of the second radar device B1 is a region in front and on the left side of the vehicle 50. The third radar device C1 is mounted on a right front side (for example, a right end of the front bumper) of the vehicle 50. A detection area of the third radar device C1 is a region in front and on the right side of the vehicle 50.

The fourth radar device B2 is mounted on a right rear side (for example, a right end of a rear bumper) of the vehicle 50. A detection area of the fourth radar device B2 is a region behind and on the right side of the vehicle 50. In other words, the fourth radar device B2 is mounted at a position diagonally opposite from a position where the second radar device B1 is mounted in the vehicle 50. In other words, the fourth radar device B2 is mounted in the vicinity of a position the farthest from the second radar device B1 in the vehicle 50. A physical distance between the position where the second radar device B1 is mounted and the position where the fourth radar device B2 is mounted prevents radio wave interference between the second radar wave to be transmitted from the second radar device B1 and the fourth radar wave to be transmitted from the fourth radar device B2.

The fifth radar device C2 is mounted on a left rear side (for example, a left end of the rear bumper) of the vehicle 50. A detection area of the fifth radar device C2 is a region behind and on the left side of the vehicle 50. In other words, the fifth radar device C2 is mounted at a position diagonally opposite from a position where the third radar device C1 is mounted in the vehicle 50. In other words, the fifth radar device C2 is mounted in the vicinity of a position the farthest from the third radar device C1 in the vehicle 50. A physical distance between the position where the third radar device C1 is mounted and the position where the fifth radar device C2 is mounted prevents radio wave interference between the third radar wave to be transmitted from the third radar device C1 and the fifth radar wave to be transmitted from the fifth radar device C2.

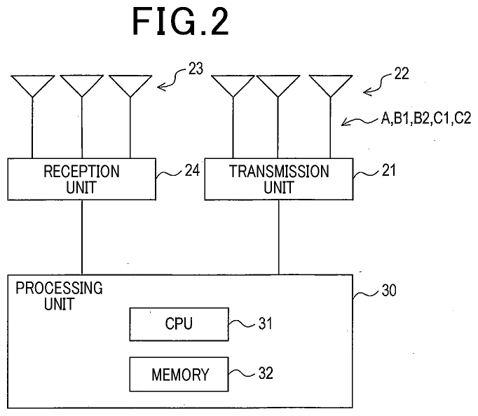

Configurations of the first to the fifth radar devices A, B1, B2, C1, and C2 will be described next with reference to FIG. 2.

Each of the first to the fifth radar devices A, B1, B2, C1, and C2 is a millimeter-wave radar including a transmission unit 21, a transmission antenna 22, a reception antenna 23, a reception unit 24 and a processing unit 30.

The processing unit 30 includes a CPU 31 and a memory 32. The processing unit 30 sets a transmission period and a transmission frequency of a radar wave to be transmitted from the transmission antenna 22 and outputs a control signal in accordance with the set transmission period and transmission frequency to the transmission unit 21.

The transmission unit 21, which includes a transmission circuit, generates a radar signal in a millimeter-wave band in accordance with the control signal input from the processing unit 30 and supplies the radar signal to the transmission antenna 22. The transmission antenna 22, which includes a plurality of antenna elements, radiates a radar wave in a millimeter-wave band in accordance with the supplied radar signal.

The reception antenna 23, which includes a plurality of antenna elements, receives a reflected wave generated by the radar wave being reflected by a target and outputs a reflection signal to the reception unit 24. The reception unit 24, which includes a reception circuit, generates a beat signal that is a mixture of the reflection signal and the radar signal and outputs a detection signal obtained by sampling the generated beat signal to the processing unit 30.

The processing unit 30 performs frequency analysis, or the like, on the acquired detection signal to calculate target information. The target information includes, for example, a distance from the vehicle 50 to the target, relative speed of the target with respect to the vehicle 50, orientation of the target with respect to the vehicle 50, and the like. The processing unit 30 then outputs the calculated target information to, for example, a travel support device.

### <2. Prevention of Radio Wave Interference>

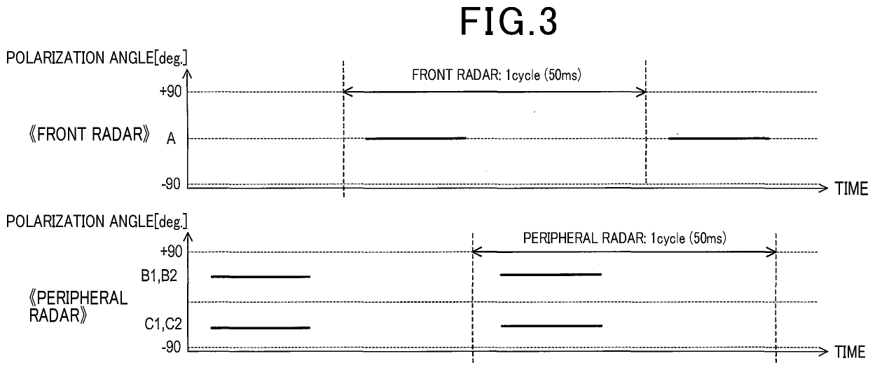

A method for preventing radio wave interference between the first to the fifth radar devices A, B1, B2, C1, and C2 will be described next with reference to FIG. 3.

As described above, the second radar device B1 and the fourth radar device B2 are mounted on a substantially diagonal line of the vehicle 50, and the detection area of the second radar device B1 and the detection area of the fourth radar device B2 face in directions substantially 180° opposite to each other. Thus, even if the same transmission period, transmission frequency and transmission polarization are set for the second radar wave to be transmitted from the second radar device B1 and the fourth radar wave to be transmitted from the fourth radar device B2, radio wave interference between the second radar device B1 and the fourth radar device B2 is prevented.

In a similar manner, even if the same transmission period, transmission frequency and transmission polarization are set for the third radar wave to be transmitted from the third radar device C1 and the fifth radar wave to be transmitted from the fifth radar device C2, radio wave interference between the third radar device C1 and the fifth radar device C2 is prevented.

Thus, the second radar device B1 and the fourth radar device B2 are grouped into the same group that will be referred to as a radar group B. Further, the third radar device C1 and the fifth radar device C2 are grouped into the same group that will be referred to as a radar group C. Then, parameters of the radar waves to be transmitted from the radar devices are adjusted so that radio wave interference does not occur between the first radar device A, the radar group B, and the radar group C. Further, the same parameters are set for the second radar wave and the fourth radar wave. The same parameters are set for the third radar wave and the fifth radar waves. The parameters of each radar wave correspond to a transmission period, a transmission frequency, and transmission polarization.

In the present embodiment, the first to the fifth radar devices A, B1, B2, C1, and C2 use a common transmission frequency and use different transmission periods and transmission polarization. Specifically, as illustrated in FIG. 3, the first radar device A transmits the first radar wave in a transmission period different from transmission periods of the second, the third, the fourth and the fifth radar waves to be transmitted from the radar devices of the radar group B and the radar group C. This prevents occurrence of radio wave interference between the first radar device A, the radar group B, and the radar group C.

Further, transmission polarization of the second and the fourth radar waves to be transmitted from the radar devices of the radar group B is orthogonal to transmission polarization of the third and the fifth radar waves to be transmitted from the radar devices of the radar group C. Specifically, the transmission antennas 22 and the reception antennas 23 of the second radar device B1 and the fourth radar device B2 are designed to have polarization angles of 45°. On the other hand, the transmission antennas 22 and the reception antennas 23 of the third radar device C1 and the fifth radar device C2 are designed to have polarization angles of −45°. This prevents occurrence of radio wave interference between the radar group B and the radar group C.

Note that while it is most preferable that an angle difference between the polarization angle of the radar group B and the polarization angle of the radar group C is 90°, the angle difference does not necessarily have to be 90° and may be an angle difference close to 90°. As the angle difference between the polarization angle of the radar group B and the polarization angle of the radar group C is closer to 90°, radio wave interference can be more reliably prevented.

Further, while in the present embodiment, the transmission antenna 22 and the reception antenna 23 of the first radar device A are designed to have polarization angles of 0°, the transmission antenna 22 and the reception antenna 23 of the first radar device A may be designed to have polarization angles that are the same as those of the radar group B or may be designed to have polarization angles thar are the same as those of the radar group C.

### <3. Effects>

According to the first embodiment described above, the following effects can be obtained.

(1) The transmission period of the first radar wave to be transmitted from the first radar device A is different from the transmission periods of the second, the third, the fourth, and the fifth radar waves to be transmitted from the radar devices of the radar group B and the radar group C. Further, the transmission polarization of the second and the fourth radar waves to be transmitted from the radar devices of the radar group B is different from the transmission polarization of the third and the fifth radar waves to be transmitted from the radar devices of the radar group C. It is therefore possible to allocate an appropriate observation period to each of the first to the fifth radar devices A, B1, B2, C1, and C2 while preventing occurrence of radio wave interference between the first radar device A, the radar group B, and the radar group C.

(2) The second radar device B1 and the fourth radar device B2 included in the radar group B are mounted diagonally opposite to each other in the vehicle 50. Thus, even if the same transmission period, transmission frequency and transmission polarization are set for the second radar wave to be transmitted from the second radar device B1 and the fourth radar wave to be transmitted from the fourth radar device B2, it is possible to prevent occurrence of radio wave interference between the second radar device B1 and the fourth radar device B2.

(3) The third radar device C1 and the fifth radar device C2 included in the radar group C are mounted diagonally opposite to each other in the vehicle 50. Thus, even if the same transmission period, transmission frequency and transmission polarization are set for the third radar wave to be transmitted from the third radar device C1 and the fifth radar wave to be transmitted from the fifth radar device C2, it is possible to prevent radio interference between the third radar device C1 and the fifth radar device C2.

### Second Embodiment

### 1. Differences from First Embodiment

The second embodiment has a basic configuration similar to that of the first embodiment, and thus, description of common components will be omitted, and differences will be mainly described. Note that reference numerals that are the same as those in the first embodiment indicate the same components, and preceding description will be referred to.

In the first embodiment described above, the first to the fifth radar devices A, B1, B2, C1, and C2 use a common transmission frequency and use different transmission periods and different transmission polarization. In contrast, the second embodiment is different from the first embodiment in that the first to the fifth radar devices A, B1, B2, C1, and C2 use a common transmission period and use different transmission frequencies and different transmission polarization.

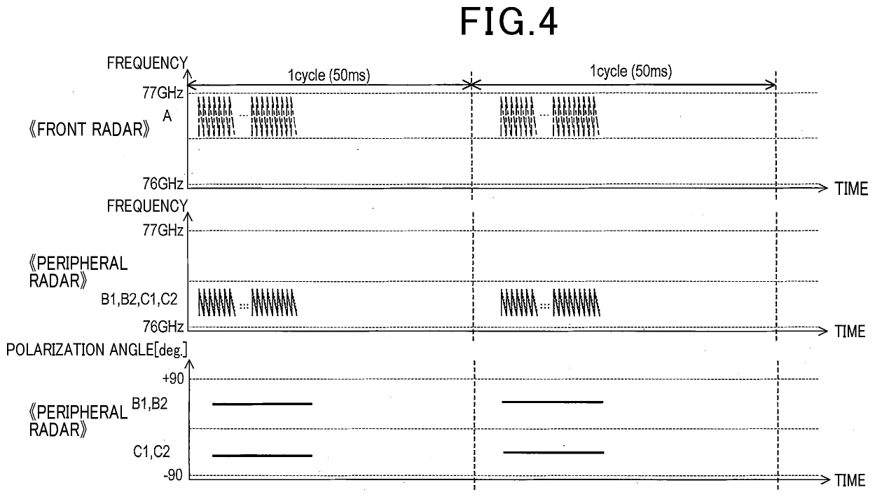

Specifically, as illustrated in FIG. 4, the first radar device A transmits the first radar wave at a transmission frequency different from the transmission frequencies of the second, the third, the fourth and the fifth radar waves to be transmitted from the radar devices of the radar group B and the radar group C. In the present embodiment, a frequency band of 76 GHz to 77 GHz is divided into two frequency bands. Then, the first radar device A transmits the first radar wave using a higher frequency band. On the other hand, the radar group B and the radar group C transmit the second, the third, the fourth and the fifth radar waves using a lower frequency band.

Further, in a similar manner to the first embodiment, the angle difference between the polarization angle of the radar group B and the polarization angle of the radar group C is designed to be 90°.

### 2. Effects

According to the second embodiment described above, in addition to the effects (2) and (3) in the first embodiment described above, the following effects can be obtained.

(4) The transmission frequency of the first radar wave to be transmitted from the first radar device A is different from the transmission frequency of the second, the third, the fourth and the fifth radar waves to be transmitted from the radar devices of the radar group B and the radar group C. Further, the transmission polarization of the second and the fourth radar waves to be transmitted from the radar devices of the radar group B is different from the transmission polarization of the third and the fifth radar waves to be transmitted from the radar devices of the radar group C. It is therefore possible to allocate appropriate frequency bands to the first to the fifth radar devices A, B1, B2, C1, and C2 while preventing occurrence of radio wave interference between the first radar device A, the radar group B, and the radar group C.

### Third Embodiment

### 1. Differences from First Embodiment

The third embodiment has a basic configuration similar to that of the first embodiment, and thus, description regarding common components will be omitted, and differences will be mainly described. Note that reference numerals that are the same as those in the first embodiment indicate the same components, and preceding description will be referred to.

In the first embodiment described above, the first to the fifth radar devices A, B1, B2, C1, and C2 use a common transmission frequency and use different transmission periods and different transmission polarization. In contrast, the third embodiment is different from the first embodiment in that the first to the fifth radar devices A, B1, B2, C1, and C2 use a common transmission frequency and use different transmission periods and different transmission frequencies.

Further, in the present embodiment, each of the first to the fifth radar devices A, B1, B2, C1, and C2 transmits two types of radar waves which are a long-range radar wave W1 and a short-range radar wave W2. In other words, each of the first, the second, the third, the fourth, and the fifth radar waves includes the long-range radar wave W1 and the short-range radar wave W2. The long-range radar wave W1 is a radar wave having a longer transmission period than that of the short-range radar wave W2. The short-range radar wave W2 is a radar wave having a wider frequency band than that of the long-range radar wave W1. In other words, the long-range radar wave W1 is a radar wave for performing measurement of a position far from the vehicle 50, and the short-range radar wave W2 is a radar wave for performing measurement of a position close to the vehicle 50 at high distance resolution.

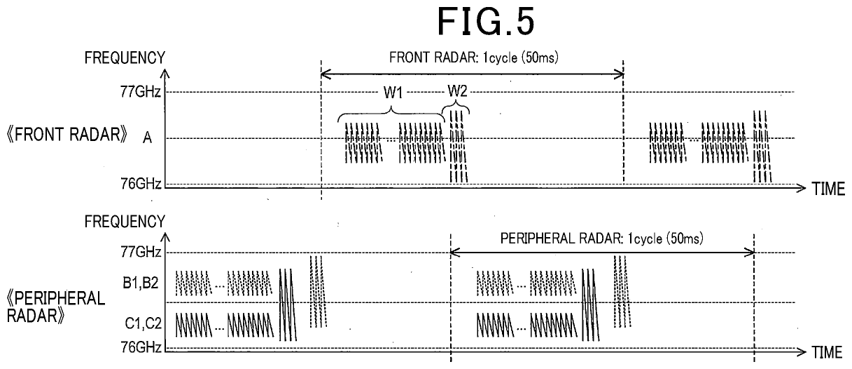

In the present embodiment, as illustrated in FIG. 5, in a similar manner to the first embodiment, the transmission period of the first radar wave of the first radar device A is set at a transmission period different from the transmission period of the second, the third, the fourth and the fifth radar waves of the radar group B and the radar group C.

Further, the radar group B and the radar group C simultaneously transmit the long-range radar waves W1 of frequency bands different from each other obtained by dividing the frequency band of 76 GHz to 77 GHz into two frequency bands. Then, the radar group B and the radar group C transmit short-range radar waves W2 in transmission periods different from each other. A frequency band of the short-range radar wave W2 of the radar group B overlaps a frequency band of the short-range radar wave W2 of the radar group C.

### 2. Effects

According to the third embodiment described above, in addition to the effects (2) and (3) of the first embodiment described above, the following effects can be obtained.

(5) The transmission period of the first radar wave to be transmitted from the first radar device A is different from the transmission period of the second, the third, the fourth, and the fifth radar waves to be transmitted from the radar devices of the radar group B and the radar group C. Further, the transmission frequency or the transmission period of the second and the fourth radar waves to be transmitted from the radar devices of the radar group B is different from the transmission frequency or the transmission period of the third and the fifth radar waves to be transmitted from the radar devices of the radar group C. It is therefore possible to allocate appropriate transmission periods and transmission frequencies to the first to the fifth radar devices A, B1, B2, C1, and C2 while preventing occurrence of radio wave interference between the first radar device A, the radar group B, and the radar group C.

### OTHER EMBODIMENTS

While the embodiments for implementing the present disclosure have been described above, the present disclosure is not limited to the above-described embodiments and can be implemented with various modifications.

(a) While in the above-described embodiments, occurrence of radio wave interference between the first radar device A, the radar group B, and the radar group C is prevented by adjusting the transmission periods, the transmission frequencies and the transmission polarization of the first radar device A, the radar group B, and the radar group C, the present disclosure is not limited to this. Occurrence of radio wave interference between the first radar device A, the radar group B, and the radar group C may be prevented by adjusting transmission beam directions in addition to the transmission periods, the transmission frequencies and the transmission polarization. For example, a transmission period different from the transmission period of the radar group B and the radar group C may be set as the transmission period of the first radar device A, and a beam direction different from a beam direction of the radar group C may be set as a beam direction of the radar group B.

(b) While the vehicle radar system 80 according to the above-described embodiments include five radar devices, the vehicle radar system 80 may include three or four radar devices. For example, the vehicle radar system 80 may include the first radar device A, the second radar device B1, and the third radar device C1 without the fourth radar device B2 and the fifth radar device C2. Further, the vehicle radar system 80 may include the first radar device A, the fourth radar device B2, and the fifth radar device C2 without the second radar device B1 and the third radar device C1. Alternatively, the vehicle radar system 80 may include the second radar device B1, the third radar device C1, the fourth radar device B2, and the fifth radar device C2 without the first radar device A.

(c) The vehicle radar system 80 and the method thereof described in the present disclosure may be implemented with a dedicated computer constituted with a processor and a memory programmed to execute one or more functions embodied by a computer program. Alternatively, the vehicle radar system 80 and the method thereof described in the present disclosure may be implemented with a dedicated computer obtained by constituting a processor with one or more dedicated hardware logic circuits. Alternatively, the vehicle radar system 80 and the method thereof described in the present disclosure may be implemented with one or more dedicated computers constituted with a combination of a processor and a memory programmed to execute one or more functions and a processor constituted with one or more hardware logic circuits. Further, the computer program may be stored in a computer-readable non-transitory tangible recording medium as an instruction to be executed by the computer. A method for implementing functions of respective units included in the vehicle radar system 80 does not necessarily have to include software, and all of the functions may be implemented using one or more pieces of hardware.

(d) A plurality of functions provided at one component in the above-described embodiments may be implemented by a plurality of components, or one function provided at one function may be implemented by a plurality of components. Further, a plurality of functions provided at a plurality of components may be implemented by one component, or one function implemented by a plurality of components may be implemented by one component. Further, part of the configurations of the above-described embodiments may be omitted. Still further, at least part of the configurations of the above-described embodiments may be added or substituted for the other configurations of the above-described embodiments.

What is claimed is:

1. A vehicle radar system comprising:
a first radar device mountable to a vehicle;
a second radar device mountable to the vehicle; and
a third radar device mountable to the vehicle, wherein
the first radar device is configured to transmit a first radar wave for which a transmission period or a transmission frequency is different from transmission periods or transmission frequencies of a second radar wave to be transmitted from the second radar device and a third radar wave to be transmitted from the third radar device, and
the second radar device is configured to transmit the second radar wave for which transmission polarization or a transmission beam direction is different from transmission polarization or a transmission beam direction of the third radar wave to be transmitted from the third radar device.

2. The vehicle radar system according to claim 1, wherein
the first radar device is configured to transmit the first radar wave for which the transmission period is different from the transmission periods of the second radar wave to be transmitted from the second radar device and the third radar wave to be transmitted from the third radar device, and
the second radar device is configured to transmit the second radar wave for which the transmission polarization is different from the transmission polarization of the third radar wave to be transmitted from the third radar device.

3. The vehicle radar system according to claim 1, wherein
the first radar device is configured to transmit the first radar wave for which the transmission frequency is different from the transmission frequencies of the second radar wave to be transmitted from the second radar device and the third radar wave to be transmitted from the third radar device, and
the second radar device is configured to transmit the second radar wave for which the transmission polarization is different from the transmission polarization of the third radar wave to be transmitted from the third radar device.

4. The vehicle radar system according to claim 1, further comprising:
a fourth radar device mountable to the vehicle, wherein
the fourth radar device is configured to transmit a fourth radar wave for which a transmission period, a transmission frequency and transmission polarization are the same as the transmission period, the transmission frequency and the transmission polarization of the second radar wave to be transmitted from the second radar device, and
the second radar device and the fourth radar device are configured to be mounted diagonally opposite on the vehicle.

5. The vehicle radar system according to claim 1, further comprising:
a fifth radar device mountable to the vehicle, wherein
the fifth radar device is configured to transmit a fifth radar wave for which a transmission period, a transmission frequency and transmission polarization are the same as the transmission period, the transmission frequency and the transmission polarization of the third radar wave to be transmitted from the third radar device, and
the third radar device and the fifth radar device are configured to be mounted diagonally opposite on the vehicle.
